(19) United States
(12) Patent Application Publication
(10) Pub. No.: US 2025/0225240 A1
(43) Pub. Date: Jul. 10, 2025

(54) GENERATING AN EFFICIENT GRAPH DATABASE FOR RELATIONSHIP QUERYING AND CYBERSECURITY ANALYSIS

(71) Applicant: Veracode, Inc., Burlington, MA (US)

(72) Inventors: Cody Allan Clements, Kansas City, MO (US); Louis Lang, Spring, TX (US); Eric Freitag, San Antonio, TX (US); Matthew Donoughe, Milford, MA (US)

(21) Appl. No.: 19/012,397

(22) Filed: Jan. 7, 2025

Related U.S. Application Data
(60) Provisional application No. 63/618,600, filed on Jan. 8, 2024.

(51) Int. Cl. G06F 21/56; G06F 8/36; G06F 16/901

(52) U.S. Cl. CPC G06F 21/56; G06F 8/36; G06F 16/9024

(57) ABSTRACT

In an embodiment, a method for generating a graph database includes identifying at least one new package in at least one source database and generating a download request associated with the at least one new package. The method includes, based on the download request, downloading the at least one new package from the at least one source database associated with the at least one new package. The method includes preprocessing the at least one new package to define at least one text representation of the at least one new package. The method includes cataloging the at least one new package based on the at least one text representation and generating a graph database based on the cataloged at least one package.

### BACKGROUND

In one or more implementations, systems and methods disclosed herein generate a graph database for relationship querying and cybersecurity analysis.

Open-source libraries are often used in software projects and account for a large portion of codebases. Including such data can result in complicated software dependencies that may be difficult to understand for a user if the user has questions regarding the data. Some known methods for analyzing data dependencies focus on individual software libraries and do not review the data holistically by examining relationships between identities, dependencies, and/or the like across the software landscape.

Analyzing across the software landscape may be desirable as malicious software may be published in more than one location by a malicious user. The malicious software may be changed from location to location and the identity of the malicious user may be obscured. Some known methods for analyzing data dependencies cannot determine commonality between the malicious software and can make a system vulnerable to a multi-faceted (e.g., published in different sources) cyber-attack.

Thus, there is a need to develop systems and methods for allowing a user to gain insight on data, including open-source libraries.

### SUMMARY

In an embodiment, a method for generating a graph database includes identifying at least one new package in at least one source database and generating a download request associated with the at least one new package. The method includes, based on the download request, downloading the at least one new package from the at least one source database associated with the at least one new package. The method includes preprocessing the at least one new package to define at least one text representation of the at least one new package. The method includes cataloging the at least one new package based on the at least one text representation and generating a graph database based on the cataloged at least one package.

### BRIEF DESCRIPTION OF THE DRAWINGS

FIG. 1 shows a block diagram of a system for generating and querying a graph database, according to an embodiment.

FIG. 2 shows a workflow for generating a graph database, according to an embodiment.

FIG. 3 shows a workflow for executing a query on a graph database, according to an embodiment.

FIG. 4 shows a method for generating a graph database, according to an embodiment.

FIG. 5 shows a method for executing a query on a graph database, according to an embodiment.

FIG. 6 shows an example of a visualization of a graph database, according to an embodiment.

FIG. 7 shows an example of data stored in a graph database, according to an embodiment.

FIG. 8 shows another example of data stored in a graph database, according to an embodiment.

FIG. 9 shows an example of an output of a query executed on a graph database, according to an embodiment.

FIG. 10 shows an example of a schema of a graph database, according to an embodiment.

### DETAILED DESCRIPTION

In some implementations, a system can identify that a package (e.g., software library, etc.) is in at least one source database (e.g., registry, etc.). In some implementations, the system monitors the at least one source database continuously, periodically, or sporadically. The system can download the package and preprocess the package. In some implementations, preprocessing can include defining at least one text representation of the package. The system can catalog the package based, in some embodiments, on the at least one text representation. In some implementations, cataloging the package can include identifying new associations based on the package. The system generates a graph database based on the cataloged package. In some implementations, the system can update the graph database based on the cataloged package.

In some implementations, the system can receive a query associated with data stored in the graph database. In some implementations, the query can be associated with a malicious information query. In some implementations, the query can be associated with functionality of data (e.g., functionality associated with the data) of the at least one text representation. The data can be analyzed based on the query to define a functionality summary. In some implementations, analyzing can include generating a concrete syntax tree associated with the data. In some implementations, the functionality summary can be based on the concrete syntax tree.

In some implementations, after the system receives the query, the system can identify at least one entry point based on the query and the graph database. In some implementations, the at least one entry point can be associated with at least one index associated with the graph database. The system can determine associations associated with the graph database based on the at least one entry point. Based on the associations, the system can generate a subgraph associated with data in the graph database that is related to the at least one entry point. The subgraph can be associated with interrelations between the data.

Generally, the system and methods described herein allow for cataloging software packages (e.g., open-source software packages, libraries, malicious software packages, etc.) across disparate software landscapes. For example, the packages can be transformed such that the packages and their associations can be represented by a graph database so that queries (e.g., questions) regarding relationships between data and packages within the graph database can be determined while using indexing for efficiently querying data. This allows a user to find desirable information quickly. Finding this information can be used to uncover security risks and vulnerabilities that may affect a consumer. For example, the systems and methods described herein can uncover cybersecurity attacks that may be related (e.g., common type, common identity, etc.), but the relationship may be obscured by a malicious user.

In some implementations, the identity can be associated with social media (e.g., X, Reddit, Facebook, etc.), issue trackers (e.g., Jira, Github, etc.), cloud services (e.g., Google, Citrix, etc.), version control systems (e.g., Git, etc.), and/or the like. In some implementations, the identity can be associated with groups (e.g., associations, organization, memberships, etc.). In some implementations, the identity can be associated with a distribution service (e.g., e-mail, etc.). In some implementations, the identity can be associated with signing keys (e.g., Pretty Good Privacy (PGP), etc.). In some implementations, the identity can be associated with a central repository (e.g., NuGet, NpmJS, etc.) package authorship. In some implementations, the identity can be associated with a contributor profile (e.g., profile, generic contact, email, username, etc.).

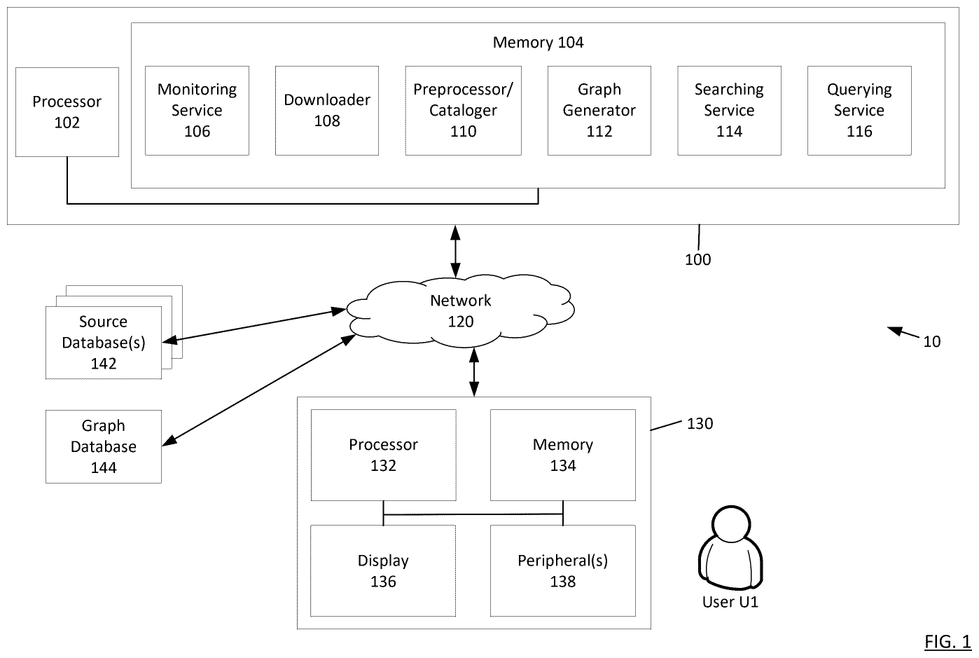

FIG. 1 shows a block diagram of a system 10 for generating and querying a graph database. In some implementations, the system 10 can be used for a cybersecurity analysis of a software landscape. The system 10 can include a querying system 100, a user compute device 130, source database(s) 142 and a graph database 144, each operatively coupled to one another via a network 120.

The network 120 facilitates communication between the components of the system 10. The network 120 can be any suitable communication network for transferring data, operating over public and/or private networks. For example, the network 120 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 120 can be a wireless network such as, for example, a Wi-Fi or wireless local area network (“WLAN”), a wireless wide area network (“WWAN”), and/or a cellular network. In some instances, the network 120 can be a wired network such as, for example, an Ethernet network, a digital subscription line (“DSL”) network, a broadband network, and/or a fiber-optic network. In some instances, the network can use Application Programming Interfaces (APIs) and/or data interchange formats, (e.g., Representational State Transfer (REST), JavaScript Object Notation (JSON), Extensible Markup Language (XML), Simple Object Access Protocol (SOAP), and/or Java Message Service (JMS). The communications sent via the network 120 can be encrypted or unencrypted. In some instances, the network 120 can include multiple networks or subnetworks operatively coupled to one another by, for example, network bridges, routers, switches, gateways and/or the like (not shown).

The user compute device 130 is a device configured to input packages, input queries, and receive and review the results from queries. The user compute device 130 can include a processor 132, memory 134, display 136, and peripheral(s) 138, each operatively coupled to one another (e.g., via a system bus). In some implementations, the user compute device 130 is associated with (e.g., owned by, accessible by, operated by, etc.) a user U1. The user U1 can be any type of user, such as, for example, a software customer, a cybersecurity reviewer, and/or the like.

The processor 132 of the user compute device 130 can be, for example, a hardware based integrated circuit (IC), or any other suitable processing device configured to run and/or execute a set of instructions or code. For example, the processor 132 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 132 can be operatively coupled to the memory 134 through a system bus (for example, address bus, data bus and/or control bus).

The memory 134 of the user compute device 130 can be, for example, a random-access memory (RAM), a memory buffer, a hard drive, a read-only memory (ROM), an erasable programmable read-only memory (EPROM), and/or the like. In some instances, the memory 134 can store, for example, one or more software programs and/or code that can include instructions to cause the processor 132 to perform one or more processes, functions, and/or the like. In some implementations, the memory 134 can include extendable storage units that can be added and used incrementally. In some implementations, the memory 134 can be a portable memory (e.g., a flash drive, a portable hard disk, and/or the like) that can be operatively coupled to the processor 132. In some instances, the memory 134 can be remotely operatively coupled with a compute device (not shown). For example, a remote database device can serve as a memory and be operatively coupled to the compute device.

The peripheral(s) 138 can include any type of peripheral, such as, for example, an input device, an output device, a mouse, keyboard, microphone, touch screen, speaker, scanner, headset, printer, camera, and/or the like. In some instances, the user U1 can use the peripheral(s) 138 to input a query. For example, the user U1 can type the query using a keyboard included in peripheral(s) 138 to indicate the query and/or select the query using a mouse included in peripheral(s) 138 to indicate the query.

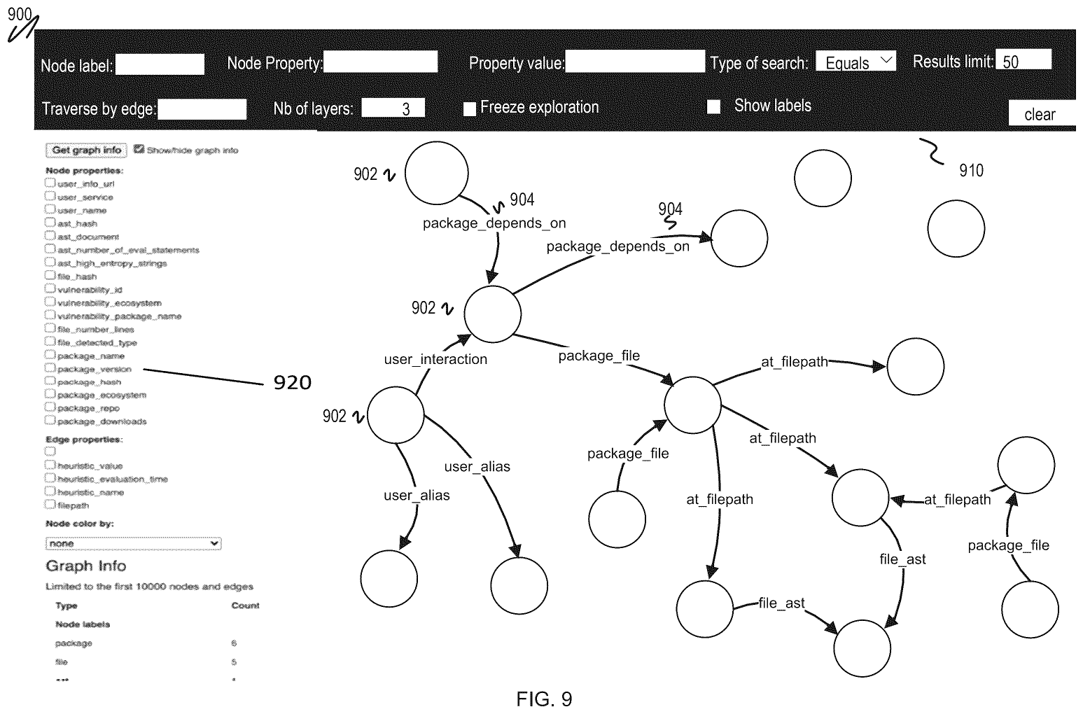

The display 136 can be any type of display, such as a Cathode Ray tube (CRT) display, Liquid Crystal Display (LCD), Light Emitting Diode (LED) display, Organic Light Emitting Diode (OLED) display, and/or the like. The display 136 can be used for visually displaying information (e.g., query results, etc.) to user U1. For example, display 136 can display a result of querying the graph database. An example output that can be displayed by the display 136 is shown in FIG. 9, described in further detail herein.

The source database 142 stores information related to the system 10 and the processes described herein. For example, the source database(s) 142 can store packages, package information, package relationships, queries, query results, source information, and/or the like. In some implementations, the source database(s) 142 can include code repositories that developers of code (e.g., open-source code) can use, maintain, and/or publish the code. In some implementations, users other than the developers can search the code repositories to access the code and/or download the code. In some implementations, the source database(s) 142 can be any number of databases including and/or storing packages. The source database(s) 142 can be any device or service configured to store signals, information, and/or data (e.g., hard-drive, server, cloud storage service, etc.). The source database(s) 142 can receive and store signals, information and/or data from the other components (e.g., the user compute device 130 and the querying system 100) of the system 10. The source database(s) 142 can include a local storage system associated with the querying system 100, such as a server, a hard-drive, or the like or a cloud-based storage system. In some implementations, the source database(s) 142 can include a combination of local storage systems and cloud-based storage systems.

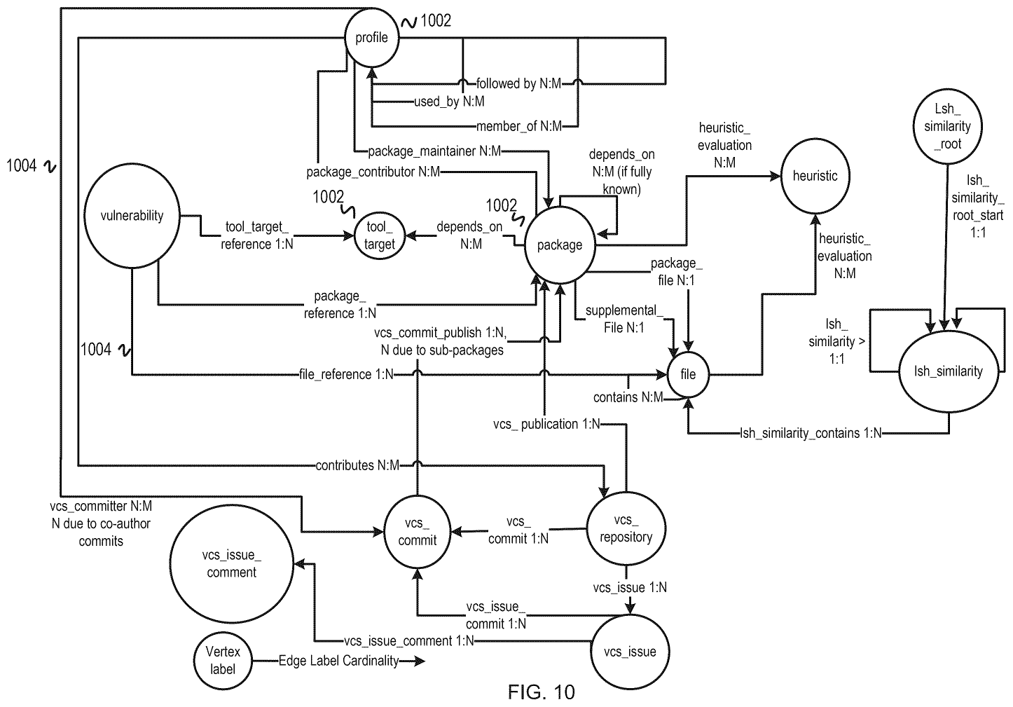

The graph database 144 stores information related to the system 10 and the processes described herein. For example, the graph database 144 includes one or more graph database(s) that store information related to packages and entities and/or associations related to and/or associated with the packages. The graph database 144 can include nodes representing different data and associations (e.g., edges) between the nodes that provide additional information on relationships between the data. The graph database 144 can be any device or service configured to store signals, information, and/or data (e.g., hard-drive, server, cloud storage service, etc.). The graph database 144 can receive and store signals, information and/or data from the other components (e.g., the user compute device 130 and the querying system 100) of the system 10. The graph database 144 can include a local storage system associated with the querying system 100, such as a server, a hard-drive, and/or the like or a cloud-based storage system. In some implementations, the graph database 144 can include a combination of local storage systems and cloud-based storage systems. In some implementations, the graph database 144 can follow a schema. An example of a schema is shown and described in reference to FIG. 10.

The querying system 100 is configured to generate graph databases and to receive and execute queries received from the user compute device 130. In some implementations, the query system 100 can be used for cybersecurity analysis (e.g., malware detection). The querying system 100 can include a processor 102 and a memory 104, each operatively coupled to one another (e.g., via a system bus). The memory 104 can include a monitoring service 106, a downloader 108, a preprocessor/cataloger 110, a package analyzer 112, a graph generator 112, a searching service 114, and a querying service 116. In some implementations, the user compute device 130 is associated with (e.g., owned by, accessible by, operated by, etc.) an organization, and the querying system 100 is associated with (e.g., owned by, accessible by, operated by, etc.) the same organization. In some implementations, the user compute device 130 is associated with (e.g., owned by, accessible by, operated by, etc.) a first organization, and the querying system 100 is associated with (e.g., owned by, accessible by, operated by, etc.) a second organization different than the first organization.

The memory 104 of the of the querying system 100 can be, for example, a random-access memory (RAM), a memory buffer, a hard drive, a read-only memory (ROM), an erasable programmable read-only memory (EPROM), and/or the like. In some instances, the memory 104 can store, for example, one or more software programs and/or code that can include instructions to cause the processor 102 to perform one or more processes, functions, and/or the like. In some implementations, the memory 104 can include extendable storage units that can be added and used incrementally. In some implementations, the memory 104 can be a portable memory (for example, a flash drive, a portable hard disk, and/or the like) that can be operatively coupled to the processor 102. In some instances, the memory 104 can be remotely operatively coupled with a compute device (not shown). For example, a remote database device can serve as a memory and be operatively coupled to the compute device.

The querying system 100 can be configured to operably communicate with the source database(s) 142 to monitor the contents and/or changes to the source database(s) 142. The querying system 100 can also receive information associated with the contents and/or changes to the source database(s) 142. The querying system 100 can output an update to a graph database of the source database(s) 142. The querying system 100 can also receive queries from the user compute device 130, execute the query, and then send the results of the query to the user compute device 130. The query can include a request (e.g., a question) associated with the data in the graph database 144, and/or relationships between the data (e.g., dependencies, identities, metadata, etc.). For example, the query can be a question such as, “which software libraries were published in the last 30 days, where the author published at least two unique packages, and both of those packages initiate connections with remote services during installation.”

In some implementations, the query can include a malicious information query. For example, the query can be associated with a malicious actor, malicious code, malicious source, and/or the like. In some implementations, the query can be updated by a user. Updating the query can allow for ad hoc querying of data in the graph database 144. In some implementations, the query can be associated with the functionality of at least a portion of the data in the graph database 144. For example, the functionality can be associated with what the data represents and/or how data may behave when implemented and/or executed by a processor (e.g., functionality that written computer code and/or instructions would cause a processor to perform when executed by that processor) and/or other information related to an implementation of the data. For example, the functionality can be associated with the use of code associated with the data. The output of the query system 100 can include a visualization of associations between data based on the request.

The monitoring service 106 is configured to monitor the contents of the source database(s) 142 to determine if new packages are added to the source database(s) 142. In some implementations, the monitoring service 106 may monitor the source database(s) 142 continuously, periodically, or sporadically. In some implementations, the monitoring service 106 may determine or receive a notification (e.g., from the source database(s) 142) that a new package was added to the source database(s) 142. In some implementations, the monitoring service 106 can be configured to monitor software management services (e.g., registries, package indices, etc.) such as npm, Crates.io, RubyGems, PyPI, Maven, NuGet, Golang, and/or the like. Once the monitoring service 106 determines that at least one new package is published in the source database(s) 142, the monitoring service 106 can generate a signal indicating the location (e.g., within the source database(s) 142) of the at least one new package as well as other information (e.g., name, size, etc.). The signal can include a download request for the at least one new package.

The downloader 108 is configured to receive the signal from the monitoring service 106. In some implementations, the downloader 108 can, based on the signal, generate the download request. Based on the download request, the downloader 108 can execute the download request to download the at least one new package from the associated source database(s) 142. In some implementations, the downloader 108 can include a download verification to verify if the download was successful. In some implementations, the downloader 108 can include a plurality of downloaders, each configured to download packages from one or more of the source database(s) 142. In some embodiments, the download can be obtained via mirrors that point to a source location.

The preprocessor/cataloger 110 is configured to receive the downloaded at least one package from the downloader 108. The preprocessor/cataloger 110 can be configured to first preprocess the at least one package to define at least one text representation associated with the at least one new package. The text representation allows for text-based searching of the data associated with the at least one new package. The underlying data that is not used for defining the at least one text representation can be stored in the graph database 144 to allow for searching of the underlying data. For example, the underlying data can be stored in the graph database 144 in such a way that allows for contextual searching of the underlying data. For example, contextual searching can include searching of the function (e.g., the function the code would perform if executed by a processor) of the underlying data, and/or the like. Storing the underlying data allows for the preprocessor/cataloger 110 to reduce processing resources used by the preprocessor/cataloger 110 as the underlying data can be searching/analyzed when desired and/or specifically requested and not during preprocessing.

In some implementations, the preprocessor/cataloger 110 can be configured to generate a concrete syntax tree (CST) associated with the at least one package. In some implementations the CST can include a CST summary document. In some implementations, the preprocessor/cataloger 110 can include security protocols that presume the downloaded at least one new package is a malicious input. The security protocols can be configured to protect the querying system 100 from zip bombs, and/or the like. For example, the package may be opened for analysis in a sandbox that is isolated from other portions of the querying system 100.

The preprocessor/cataloger 110 is configured to catalog the at least one new package. In some implementations, cataloging can be based on the at least one text representation. Cataloging can include cataloging based on information associated with the at least one package, files within the at least one package, social information associated with the at least one package, open-source information (e.g., exposure) associated with the at least one package, and/or the like. The information associated with the at least one package can include a description, file path, package license information, package publication information, a source code repository association, a package URL (PURL) associated with the package, repository metadata, and/or the like. The files within the at least one package can include information such as a checksum, similarity with other files, type identification, file path within the package, license information, media type (e.g., PDF, music file, picture, etc.), file size, number of lines of code, text content, source code language, CST summary, processing information (e.g., password protection, zip bomb, etc.) etc. If the files are identified as source code, the files can include information such as unique hard coded values, variable names, code expressions with particular functions, and/or the like. Social information can include publications under a given identity on repositories, repository website identities, emails, source control (e.g., Git, GitHub, GitLab, etc.) identities (e.g., usernames), social media profiles (e.g., X (Twitter), Reddit, Facebook (Meta), etc.), signing key possession and usage, metadata attribution (e.g., publishing notes), and/or the like. The open source information can include dependencies and/or dependents of the at least one package.

In some implementations, the preprocessor/cataloger 110 is configured to index the at least one package and/or the information associated with the at least one package. In some implementations, the preprocessor/cataloger 110 is configured to generate checksums associated with the at least one package. In some implementations, the checksums generated by the preprocessor/cataloger 110 can be indexed. In some implementations, the preprocessor/cataloger 110 is configured to generate a locality-sensitive hash (LSH) associated with the at least one package. The LSH can be used during query execution to determine distances between nodes on the graph.

The graph generator 112 is configured to store the cataloged at least one new package in a graph stored in the graph database 144. The graph includes nodes for packages, files, identities, and/or the like. In some implementations, the nodes can include metadata. The connections between the nodes can indicate relationships (e.g., associations) between the nodes. In some embodiments, the graph database can be based on a backing database such as Janusgraph, Neo4j, and/or the like. In some embodiments, the graph database(s) 144 can store a copy of past graphs. For example, the graph database(s) 144 can generate and store a copy of the current graph prior to updating the graph. This allows for previous graphs to be queried (e.g., to determine how a security event may have occurred) or as a backup. In some embodiments, the graph generator 121 indexes the graph so that data can be found and/or identified efficiently. In some implementations, the indexing operations of the preprocessor/cataloger 110 can be completed by the graph generator 112 during implementation of the cataloged at least one package into the graph database 144.

The searching service 114 is configured to search the graph database 144 based on the query. Generally, the searching service 114 is configured to identify entry point(s) into the graph database 144 based on the query and based on the cataloged data in the graph database 144. To identify the entry point(s), the searching service 114 can determine or receive vectors of interest in the query. The vectors of interest can be associated with any of the cataloged information in the graph database 144. The entry point(s) are one more nodes on the graph database 144 that are associated with the query and allow for results of the query to be found more efficiently than by identifying each node in the graph database 144 that may be associated with the query. In some implementations, the entry point(s) can be associated with a plurality of data types. Once the entry point is determined, the searching service 114 can follow associations between the nodes to generate a subgraph of the graph database 144. The subgraph can be the output of the query and can be displayed to the user U1 for review and/or for further querying.

More specifically, the searching service 114 can identify entry point(s) based on file properties in the graph database 144. For example, the searching service 114 can identify entry point(s) based on checksums associated with the data as the checksums in the graph database 144 are indexed. The entry point(s) can be identified based on file similarity in the graph database 144. For example, similarity distance (e.g., based on LSH) can be used to find entry point(s) that are similar to queried information. In some implementations, the entry point(s) can be identified based on file type. For example, the searching service 114 can identify entry point(s) based on a file type(s) indicated within the query. In some implementations, the entry point(s) can be identified based on file path. For example, a query can indicate a particular location (e.g., file location, source location, etc.), and the searching service 114 can identify entry point(s) that are associated with the particular location. In some implementations, the entry point(s) are identified based on features of source code. For example, entry point(s) can be identified based on certain hard coded values and/or variable names in source code. As another example, entry point(s) can be identified based on certain code expressions that perform particular functions such as containing a location identifier of interest or a host location within a string. In some implementations, the entry point(s) can be identified based on a PURL. For example, the entry point(s) can be associated with a particular package, a family of packages, a subset of a family of packages that match a qualifier, and/or the like.

In some implementations, the searching service 114 is configured to identify entry point(s) based on social information. In some implementations, entry point(s) are identified based on publications under a given identity. For example, the entry point(s) can be identified based on a direct lookup of the given identity or based on flexible searching of the given identity, which can include identifying common prefixes of a username or domain names in the username. In some implementations, the entry point(s) can be identified based on aliases of a user. In some implementations, entry point(s) can be identified based on associations of a user with known malicious actors. For example, entry point(s) can be identified based on collaborations between the user and known malicious actors. In some implementations, the searching service 114 is configured to identify entry point(s) based on exposure (e.g., dependencies) of the package. For example, the entry point(s) can be identified as a family of packages that are either dependent on the package or on which the package depends. In some implementations, the search service 114 is configured to identify entry point(s) based on the maintaining user of an open-source package. In some implementations, the entry point(s) can be identified based on information associated with the packages, such as a package description, source code repository association, metadata, etc. For example, entry point(s) can be determined based on nodes that include duplicated metadata, descriptions, and/or the like. In some implementations, the searching service 114 can be configured to generate any number of entry point(s) based on the information indicated in the query.

After identifying the entry point(s), the searching service 114 generates a subgraph of the graph database 144 based on the entry point(s) and the associations between the entry point(s). For example, the subgraph can include nodes and associations that originate at and/or are connected to the entry point(s) in the graph. The subgraph allows for a user to search only a portion of the entire graph database 144, thus improving the efficiency of querying the graph database 144. In some implementations, the subgraph can be displayed to the user for review and/or for further querying. In some implementations, the query can include an indication that a contextual analysis is desired. For example, the searching service 114 may be configured to analyze the underlying data of the graph database 144 to determine context associated with the subgraph and/or results of the query. For example, the searching service 114, based on a query associated with functionality, can analyze the data in the in the graph database 144 to determine a contextual summary (e.g., functionality summary) associated with some information associated with at least one package. The contextual summary can provide a user with insight on how a package may be used when implemented and/or other functions associated with packages. As another example, the contextual analysis can include determining if the underlying data includes an indication that a node or other portion of the subgraph includes malicious content. The contextual analysis can provide insight on the results of the query. For example, if a query includes a text-based search of an identity of a malicious actor, the contextual analysis can determine which results of the query include or do not include malicious content.

The querying service 116 is configured to receive the query from the user compute device 130. The querying service 116, in some implementations can be configured to generate possible queries for the user U1 to choose and/or select. For example, the querying service 116 can be configured to determine which associations between nodes on the graph are able to be used during a query. In some implementations, the querying service 116 can receive one or more query updates that include one or more modification to the query. The querying service 116 can be configured to implement the modification(s) into the query to allow the modified query to be executed by the querying system 100. In some implementations, updating the query by the querying service 116 can allow for ad hoc live querying of the graph database 144.

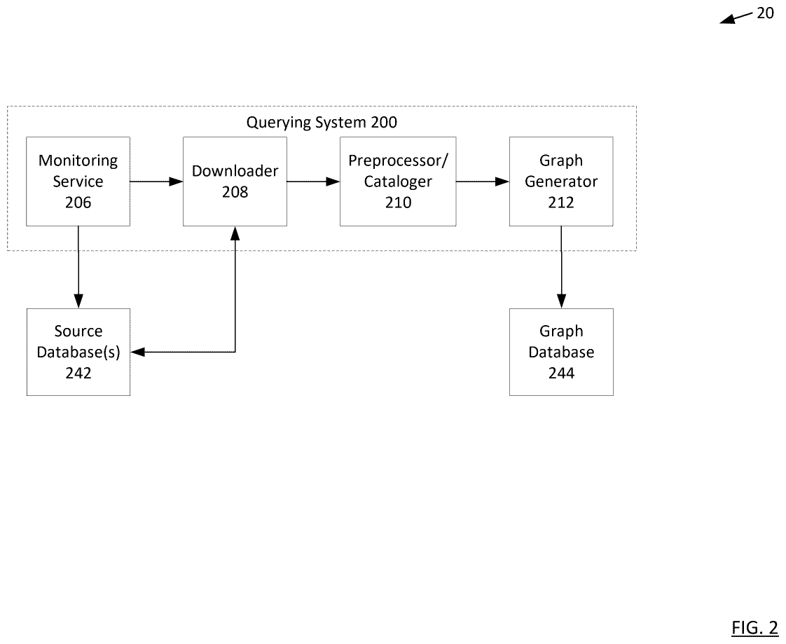

FIG. 2 shows a workflow 20 for generating a graph database, according to an embodiment. The workflow 20 can be represented as software code stored on one or more memories (e.g., structurally and/or functionally similar to memory 104 in FIG. 1) and/or executed on one or more processors (e.g., structurally and/or functionally similar to processor 102 in FIG. 1). For example, the processes described in reference to FIG. 2 can be executed by the one or more processors while the instructions can be stored on the one or more memories. The workflow 20 includes source database(s) 242 (e.g., structurally and/or functionally similar to the source database(s) 142 of FIG. 1), a graph database 244 (e.g., structurally and/or functionally similar to the graph database 144 of FIG. 1), and a querying system 200 (e.g., structurally and/or functionally similar to the querying system 100 of FIG. 1) including a monitoring service 206 (e.g., structurally and/or functionally similar to the monitoring service 106 of FIG. 1), a downloader 208 (e.g., structurally and/or functionally similar to the downloader 108 of FIG. 1), a preprocessor/cataloger 210 (e.g., structurally and/or functionally similar to the preprocessor/cataloger 210 of FIG. 1), a package analyzer 212, and a graph generator 212 (e.g., structurally and/or functionally similar to the graph generator 112 of FIG. 1). In some implementations, the graph database 244 can be stored on a memory (not shown in FIG. 2) of the querying system 200. In some implementations, the querying system 200 may be communicatively coupled to the source database(s) 242 and the graph database 244 via a network (not shown in FIG. 2), such as the network 120 of FIG. 1.

The monitoring service 206 is configured to monitor the source database(s) and determine if at least one new package is published on at least one of the source database(s) 242. In some implementations, the monitoring service 206 can determine if the at least one new package is published based on monitoring the source database(s) 242 or, in some implementations, the monitoring service 206 can receive an indication (e.g., notification, signal, etc.) from the source database(s) 242 that at least one new package has been published. Upon determining that at least one new package is published, the monitoring service 206 generates a download request for requesting to download the at least one new package from the source database(s) 242. In some embodiments, the download request can include the at least one new package name, location, or other identifying information. After generating the download request, the monitoring service 206 sends the download request to the downloader 208.

The downloader 208 is configured to receive the download request. In some embodiments, the downloader 208 may be configured to generate the download request based on the monitoring service 206 determining that at least one new package is published. The downloader 208 may send the download request to the source database(s) 242 and then may receive and download the at least one package from the source database(s) 242. After successfully downloading the at least one new package, the downloader 208 sends the downloaded at least one new package to the preprocessor/cataloger 210.

The preprocessor/cataloger 210 is configured to preprocess the at least one new package. In some implementations, preprocessing the at least one new package can include defining at least one text-based representation associated with the at least one new package. The text-based representation allows for text-based searching of the data associated with the at least one new package and allows for the data to be queried more efficiently than without preprocessing. In some implementations, the unprocessed data (e.g., underlying data) is also stored with the preprocessed data, as it can provide further insight that may not be apparent in the preprocessed data when executing a query on the data. In some implementations, the preprocessor/cataloger 210 can be configured to generate a concrete syntax tree (CST) associated with the at least one package. In some implementations the CST can include a CST summary document.

The preprocessor/cataloger 210 is configured to catalog the at least one new package. In some implementations, cataloging can be based on the at least one text representation and/or the underlying data. Cataloging can include generally cataloging the data into a profile, a package, a dependency, a file, and/or the like. Cataloging into a profile can include cataloging based on an identity, a repository website, an email, a social media profile, possession of signing keys, source control identity (e.g., website username, signing keys used, etc.), metadata, and/or the like. Cataloging into a package can include cataloging based on a package's PURL, metadata, a description, license information, publication information (e.g., location, timestamp, etc.) Cataloging into a dependency can include cataloging based on package dependencies, the name of the dependency, version of the package and/or a file in the package, and/or the like. Cataloging a file can include cataloging based on checksum, file path, file location, file license, file type, file size, number of lines of code, text content, source code language, CST summary, LSH, and/or the like.

In some implementations, the preprocessor/cataloger 210 is configured to index the at least one package and/or the information associated with the at least one package. In some implementations, the preprocessor/cataloger 210 is configured to generate checksums associated with the at least one package. In some implementations, the checksums generated by the preprocessor/cataloger 210 can be indexed. In some implementations, the preprocessor/cataloger 210 is configured to generate a locality-sensitive hash (LSH) associated with the at least one package. The LSH can be used during query execution to determine distances between nodes on the graph.

The graph generator 212 is configured to insert the preprocessed and cataloged at least one new package into the graph database 244. The graph database 244 includes a graph that includes nodes for packages, files, identities, entities, social media accounts, usernames, geographic locations, and/or the like. The at least one new package can be used by the graph generator 212 to generate new nodes in the graph and to generate associations based on the existing nodes in the graph and the new node. For example, if the at least one new package is a new node and the information includes profile information, the graph generator 212 can generate associations between the new node and existing nodes that are also associated with the profile information. In some implementations, the graph in the graph database 244 can be accessed by a user to view the nodes and associations between the nodes. In some implementations, the graph may be displayed on a graphical user interface (GUI) to allow for the user to interact with the graph.

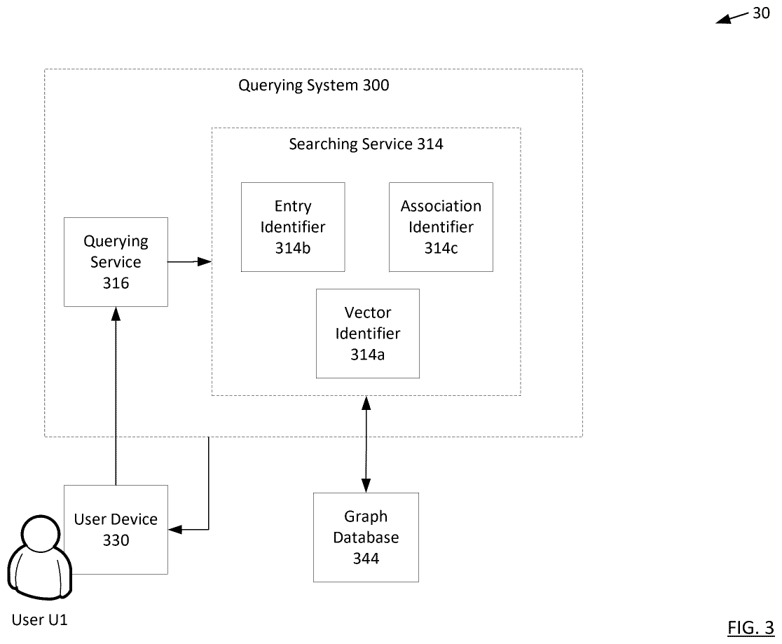

FIG. 3 shows a workflow 30 for executing a query on a graph database, according to an embodiment. The workflow 30 can be stored in one or more memories and/or executed by one or more processors. For example, the processes described in reference to FIG. 3 can be executed by the one or more processors while the instructions can be stored on the one or more memories. The workflow 30 includes a user device 330 (e.g., structurally and/or functionally similar to the user device 130 of FIG. 1) associated with the user U1, a graph database 344 (e.g., structurally and/or functionally similar to the graph database 144 of FIG. 1), and a querying system 300 (e.g., structurally and/or functionally similar to the querying system 100 of FIG. 1).

The querying system 300 includes a querying service 316 (e.g., structurally and/or functionally similar to the querying service 116 of FIG. 1), a searching service 314 (e.g., structurally and/or functionally similar to the searching service 114 of FIG. 1) including a vector identifier 314a, an entry identifier 314b, and an association identifier 314c, and a package analyzer 310 (e.g., structurally and/or functionally similar to the package analyzer 110 of FIG. 1), and a search identifier 314 (e.g., structurally and/or functionally similar to the search identifier 116 of FIG. 1).

The querying service 316 is configured to receive at least one query from the user device 330. The at least one query can include a question (e.g., request) associated with the data in the graph database 344. For example, the query can include a question regarding a source of code, an identity associated with the code, a code dependency, maliciousness of code and/or the like. The query can allow the user U1 to gain additional insight on the data in the graph database 344. For example, the query can be motivated by the user U1 attempting to determine the source of a cybersecurity event (e.g., breach), prevent a cybersecurity event, strength a cybersecurity system, and/or the like. In some embodiments, the query can include information regarding the function of the querying system 300. For example, the query can include an indication of information that is desired by the user such as a vector of-interest and/or the like. This allows for the user U1 to customize the functionality of the querying system 300 to suit the needs of the user U1. After receiving the query, the querying service 316 sends the query to the query analysis 301.

The searching service 314 is configured to execute the query on the graph database 344. Generally, the searching service 314 may be configured to determine the information that is indicated to be desired by the user U1 in the query. The vector identifier 314a determines at least one vector from the query. The at least one vector can be associated with the information cataloged in the graph database 344. For example, the at least one vector can include file information, social information, open source exposure, package information, and/or the like. The entry identifier 314b receives the at least one vector from the vector identifier 314a and identifies at least one entry point. The entry point(s) correspond to nodes and/or associations that can be used as starting points for generating a subgraph as an output for the query. The entry point(s) can be identified as nodes and/or associations that are associated with the at least one vector. For example, for a vector related to file information, the entry point(s) can be associated with checksums, file similarity, file type, file path, and/or the like. As another example, for a vector related to social information, the entry point(s) can be associated with publications, identity, usernames, aliases, partial usernames, emails, social media accounts, associations with other users, and/or the like.

The association identifier 314c is configured to determine a subgraph of nodes in the graph database 344 that are associated with the entry point(s). Determining the subgraph can be based on existing associations in the graph database 344 as well as the query. For example, if the query indicates certain associations are desired, the association identifier 314c determines a subgraph based on the entry point(s) and the nodes that are associated with the entry point(s) via the desired associations.

Once the searching service 314 has finished generating the subgraph, the subgraph can be sent to the user device 330 for review. The user U1 can review the subset of data, and, in some implementations, generate a new query associated with the subset of data and/or based on the subset of data. In some implementations, the results of the query can be stored in a database, such as the graph database 344. In some implementations, the query and the results of the query can be used for cybersecurity analysis. For example, if a malicious actor is found by a cybersecurity reviewer, the query can be configured to yield results that include data associated with the malicious actor, thus allowing the cybersecurity reviewer to determine risk and/or mitigate risk.

In some implementations, the searching service 314 can be configured to analyze the underlying data related to the nodes and associations in the subgraph. Analyzing the underlying data can include determining the context of the data. For example, a query can indicate that searching the graph database 344 for nodes associated with a certain identity (e.g., malicious actor) is desired. Once a subgraph is generated based on the query, the subgraph can be analyzed to determine the context of the nodes identified. For example, the context can provide the user U1 with insight on whether the nodes are potentially malicious or not.

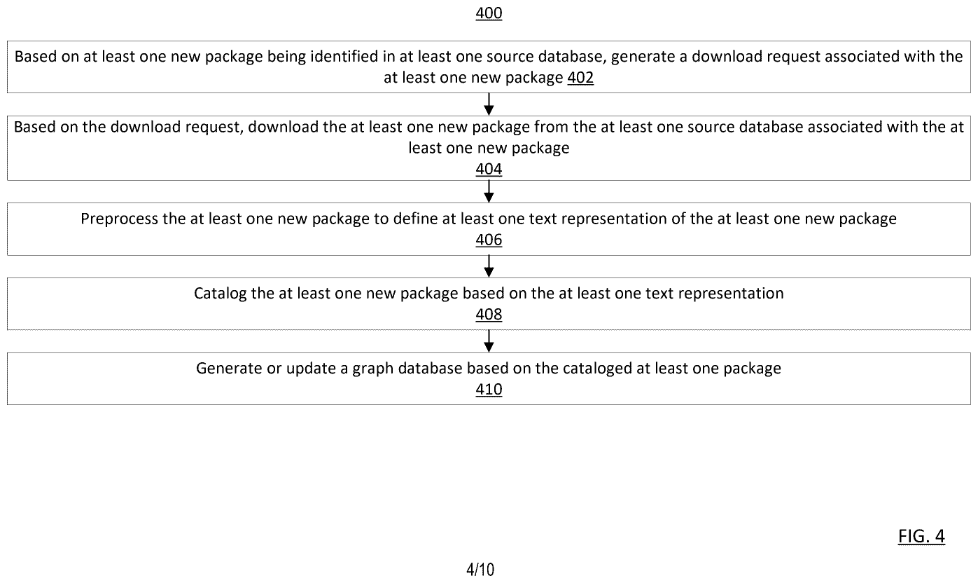

FIG. 4 shows a method 400 for generating a graph database, according to an embodiment. The method 400 can be executed by a system such as the system 10 of FIG. 1 (e.g., by processor 102 of system 10). The method 400 includes generating, based on at least one new package being identified in at least one source database, a download request associated with the at last one new package, at 402; downloading, based on the download request, the at least one new package from the at least one source database associated with the at least one new package, at 404; preprocessing the at least one new package to define at least one text representation of the at least one new package, at 406; cataloging the at least one new package based on the at least one text representation, at 408; and generating or updating a graph database based on the cataloged at least one package, at 410.

At 402, based on the at least one new package being identified in at least one source database, a download request associated with the at least one new package is generated. In some implementations, the at least one new package is identified based on monitoring of the at least one source database. In some implementations, the at least one source database can include an open-source ecosystem. In some implementations, the at least one source database can include npm, PyPI, Crates.io, NuGet, Maven Central, Golang, RubyGems, and/or the like. The download request can be a request to download at least a portion of the at least one new package. Once the download request is generated, the download request may be sent to the at least one source database for downloading.

At 404, based on the download request, at least one new package from the at least one source database associated with the at least one new package is downloaded. In some implementations, the downloaded at least one new package can be verified to ensure that the download was correctly downloaded. For example, file size, file origin, content, and/or the like can be verified. As another example, the checksum can be calculated and compared to a checksum associated with the at least one new package to verify the correct file was downloaded and/or desirable installation.

At 406, the at least one new package is preprocessed to define at least one text representation of the at least one new package. The at least one text representation allows for text-based searching of the data associated with the at least one new package. For example, the at least one text representation can be used to determine what is textually in the at least one new package. The underlying data that is not used for defining the at least one text representation can be stored in the graph database to allow for searching of the underlying data. The underlying data can be used to determine a functionality of the at least one package. For example, the functionality can include how the at least one package is used when implemented. In some implementations, preprocessing can include generating a concrete syntax tree (CST) associated with the at least one package. In some implementations the CST can be used to define a CST summary document. In some implementations, preprocessing can include generating checksums associated with the at least one new package. In some implementations, the preprocessing can include generating a locality-sensitive hash (LSH) associated with the at least one package.

At 408, the at least one new package is cataloged based on the at least one text representation. Cataloging can include cataloging based on information associated with the at least one package, files within the at least one package, social information associated with the at least one package, open-source information (e.g., exposure) associated with the at least one package, and/or the like. The information associated with the at least one package can include a description, file path, package license information, package publication information, a source code repository association, a PURL associated with the package, repository metadata, and/or the like. The files within the at least one package can include information such as a checksum, similarity with other files, type identification, file path within the package, license information, media type (e.g., PDF, music file, picture, etc.), file size, number of lines of code, text content, source code language, CST summary, processing information (e.g., password protection, zip bomb, etc.) etc. If the files are identified as source code, the files can include information such as unique hard coded values, variable names, code expressions with particular functions, and/or the like. Social information can include publications under a given identity on repositories, repository website identities, emails, source control (e.g., Git, GitHub, GitLab, etc.) identities (e.g., usernames), social media profiles (e.g., X (Twitter), Reddit, Facebook (Meta), etc.), signing key possession and usage, metadata attribution (e.g., publishing notes), and/or the like. The open source information can include dependencies and/or dependents of the at least one package.

In some implementations, cataloging can further include indexing the at least one new package, the at least one text representation, and/or the information associated with the at least one new package. In some implementations, the checksums associated with the at least one new package can be indexed.

At 410, a graph database is generated or updated based on the cataloged at least one package. In some implementations, the graph database can be built on a backing database such as Neo4j or Janusgraph. Generating the graph database can include generating nodes of the graph database and associated associations between the nodes based on the at least one new package. Updating the graph database can include updating the graph database with additional nodes associated with the at least one new package. Updating the graph database can then include assigning associations between the additional nodes and the existing nodes in the graph database. The updated graph is then ready to be queried. The method 400 can return to 402 when another at least one package is identified in the source database.

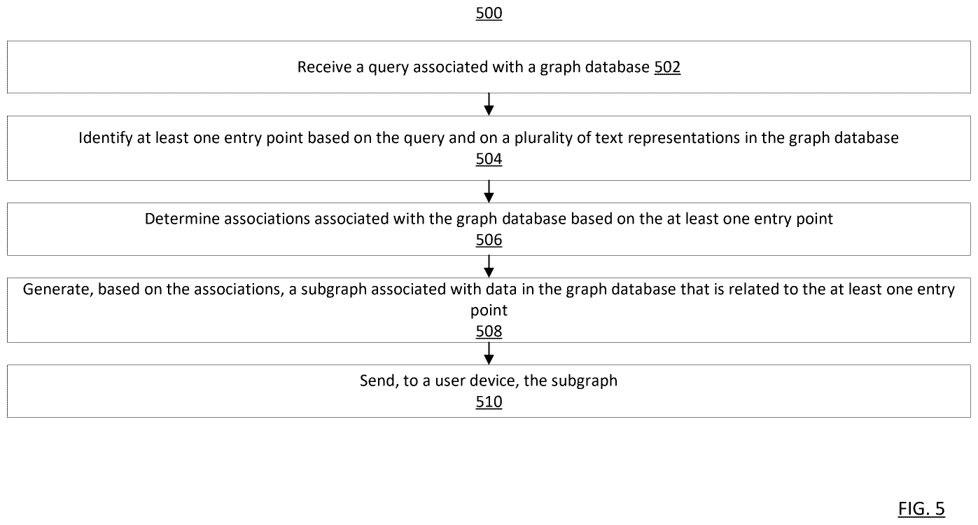

FIG. 5 shows a method 500 for executing a query on a graph database, according to an embodiment. The method 500 can be executed by a system such as the system 10 of FIG. 1 (e.g., by processor 102 of system 10). The method 500 includes receiving a query associated with a graph database, at 502; identifying at least one entry point based on the query and on a plurality of text representations in the graph database, at 504; determining associations associated with the graph database based on the at least one entry point, at 506; generating, based on the associations, a subgraph associated with data in the graph database that is related to the at least one entry point, at 508; and sending, to a user device, the subgraph, at 510.

At 502, a query is received. The query associated with a graph database. The query can include a question (e.g., request) associated with the data in the graph database. For example, the query can include a question regarding a source of code, an identity associated with the code, a code dependency, maliciousness of code and/or the like. The query can allow the user to gain additional insight on the data in the graph database. For example, the query can be motivated by the user attempting to determine the source of a cybersecurity event (e.g., breach), prevent a cybersecurity event, strength of a cybersecurity system, and/or the like. In some embodiments, the query can include information regarding query execution. For example, the query can include an indication of information that is desired by the user such as a vector of-interest and/or the like.

At 504, at least one entry point is associated based on the query and on a plurality of text representations in the graph database. In some implementations, such as when the query includes vectors, the at least one entry point can be determined based on the vectors. As another example, the vectors can be determined based on the query. In some embodiments, the vectors can be associated with the plurality of text representation in the graph database. For example, the vectors can include file information, social information, open-source exposure, package information, and/or the like. The at least one entry point can be identified as nodes and/or associations that are associated with the vectors. For example, for a vector related to file information, the at least one entry point can be associated with checksums, file similarity, file type, file path, and/or the like. As another example, for a vector related to social information, the at least one entry point can be associated with publications, identity, usernames, aliases, partial usernames, emails, social media accounts, associations with other users, and/or the like.

At 506, associations are determined. The associations are associated with the graph database based on the at least one entry point. The associations are relations between nodes in the graph database based on the at least one entry point. In some implementations, the associations can be determined based on the query. At 508, a subgraph is generated based on the associations. The subgraph is associated with data in the graph database that is related to the at least one entry point. The subgraph may include a subgraph of nodes in the graph database that are associated with the at least one entry point and the associations determined in 506. In some implementations, the method 500 can include analyzing the underlying data associated with the subgraph to determine a context associated with at least a portion of the subgraph. In some implementations, the context can be determined based on the query indicating that context is desired. The context can include information regarding the functionality of the at least a portion of the subgraph (e.g., functionality that a code would cause if the code were executed by a processor), insight on the desired information, and/or the like.

At 510, the subgraph is sent to the user device. The subgraph can be displayed to a user associated with the user device. In some implementations, the subgraph can be viewed by the user as a graph with nodes and associations shown, as seen in FIG. 9. In some implementations, the user can interact with the data subset via a graphical user interface to examine associations between the nodes. In some implementations, the user can query the data subset to further refine the data subset. For example, a first query from the user can be a broad query and the second query can be more specific. The method 500 can return to 502 when an additional query is received.

In some implementations, the method 400 and the method 500 can be executed for the same graph database. For example, the system may monitor for new packages while processing queries on the graph database, allowing for querying of recent and relevant information.

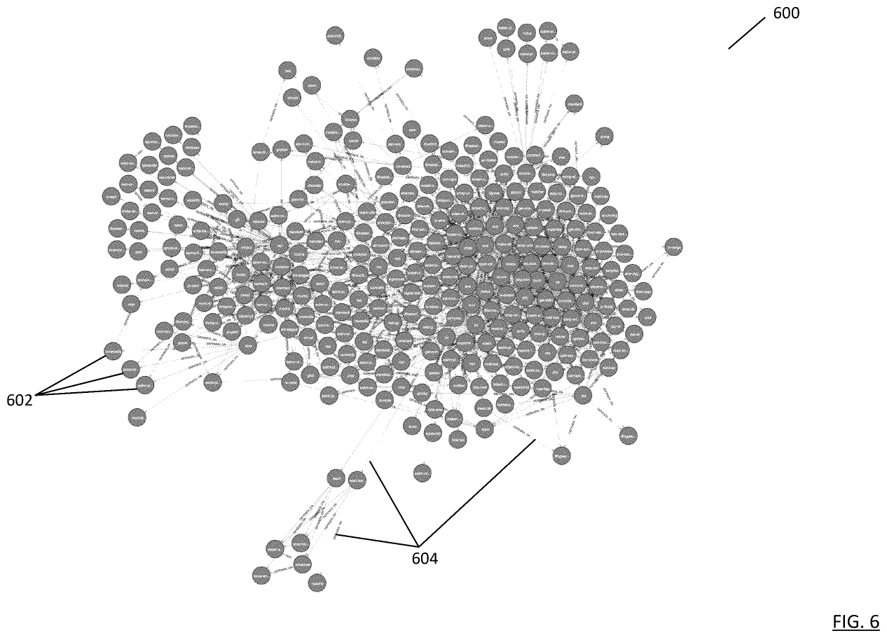

FIG. 6 shows an example of a visualization of a graph database 600, according to an embodiment. The graph database 600 includes nodes 602. The nodes 602 can be associated with files, packages, identity, entities, social media accounts, usernames, geographic locations, and/or other information. The graph database 600 can include any number of nodes 602. Relationships between the nodes 602 can be defined by associations 604. For example, the relationships can be shown in the visualization of the graph database 600 as lines and/or edges between the nodes 602. In some implementations, the length of the associations 604 may correspond to how similar connected nodes 602 may be. The associations 604 can indicate dependencies, relationships (e.g., common identity, same location, etc.), and/or the like. As described herein, the graph database allows for querying such that an output of a query can be a subgraph of the graph database 600 that includes nodes 602 and associations 604 that are associated with the information of-interest in the query. As described herein, the nodes 602 and/or the associations 604 can be identified as entry point(s) to the graph database 600 based on a query. When the query is executed, a subgraph can then be generated based on the entry point(s) and how the entry point(s) are associated with other nodes 602 based on the associations 604.

In some implementations, the graph database 600 may be displayed in a graphical user interface (GUI). The GUI can be configured so that a user may select one or more node 602 and/or associations 604. Selecting a node 602 and/or an association 604 can highlight or isolate a subgraph that includes the nodes 602 (and associated associations 604) that are all connected via the associations 604. In some implementations, the user can then further filter the subgraph. For example, the user can select only nodes 602 that include associations 604 related to an identity. As another example, the subgraph can be filtered to include nodes that are recent (e.g., within an entered amount of time).

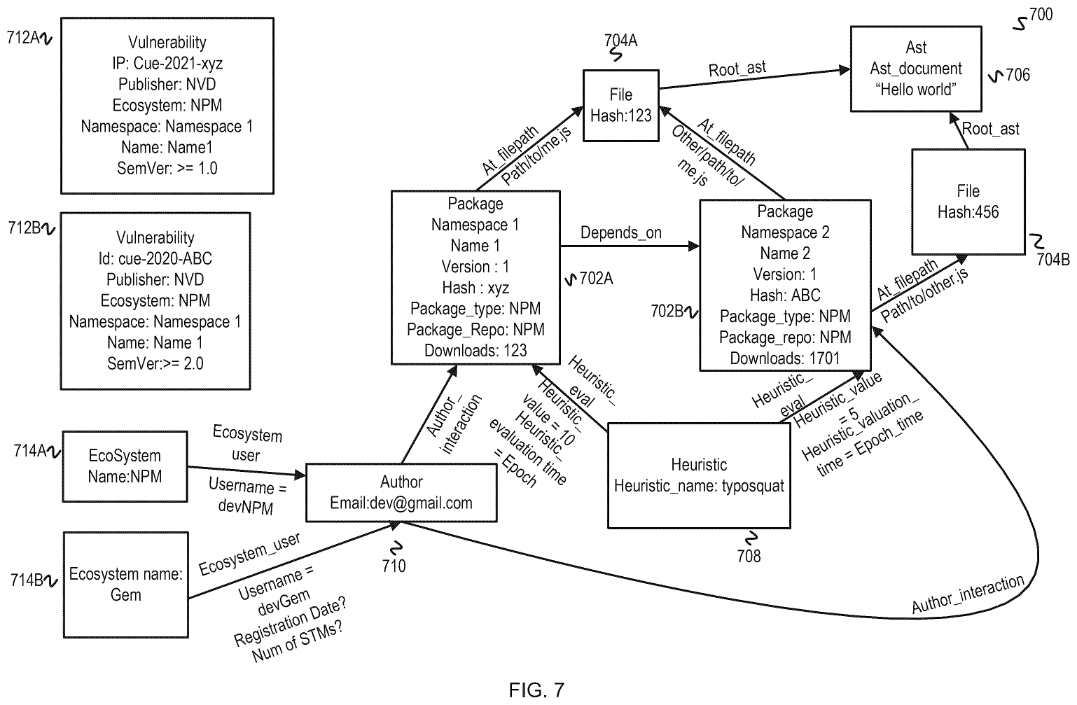

FIG. 7 shows an example of data stored in a graph database 700, according to an embodiment. The graph database 700 can include various nodes shown as packages 702a, 702b, files 704a, 704b, syntax tree 706, heuristic information 708, author information 710, vulnerability information 712a, 712b, and ecosystem information 714a, 714b. As described herein, the nodes can be identified as entry point(s) to executing a query. The associations between the nodes can then be used to connect the entry point to other nodes to generate a subgraph as an output to the query. The graph database 700 can be queried using the associations. For example, an execution of the query can output a subgraph that includes information that is related based on what is desired as indicated in the query.

The packages 702a, 702b can include identifiers, version numbers, hash information, package type, package repository information, and a number of downloads. The first package 702a and the second package 702b in the graph database 700 are associated by a dependency association, where the first package 702a depends on the second package 702b. The file 704a is associated with the first package 702a and the second package 702b based on file-path dependencies. The file 704a includes a hash. The syntax tree 706 is associated with the file 704a and the file 704b via root associations. Syntax tree 706 can include a document including associated information. The file 704b is associated with the second package 702b. The file 704b includes a hash.

The heuristic information 708 includes a heuristic name and is associated with the first package 702a and the second package 702b. The author information 810 includes an email address associated with an author. The author information 810 is associated with the first package 702a and the second package 702b with an author interaction association. The author information is associated with a first ecosystem 714a and a second ecosystem 714b as the author information 810 is associated as a user in the ecosystems 714a, 714b. The ecosystems 714a, 714b are, in some implementations, source databases. The association between the ecosystems 714a, 714b can include a username, a registration date, and/or the like. The vulnerabilities 712a, 712b can include an identification, publisher information, source information, naming information, and/or the like.

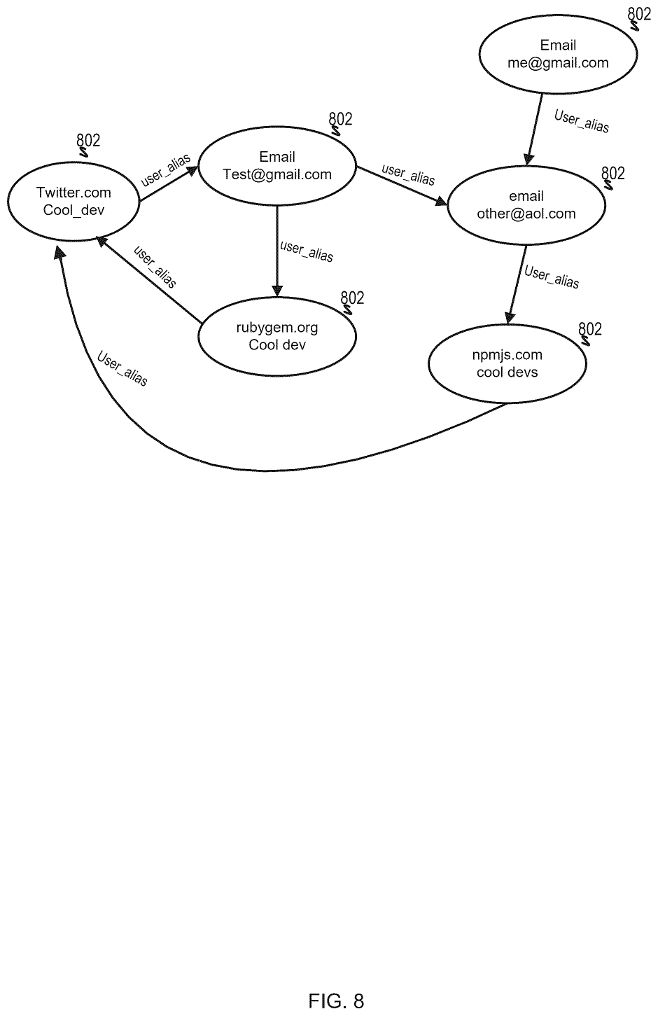

FIG. 8 shows another example of data stored in a graph database 800, according to an embodiment. As seen in FIG. 8, the graph includes nodes 802 that correspond to various aliases associated with a user. Each alias can be related to another alias via an alias association. These associations can be used during querying to determine a subgraph of packages associated with a user regardless of the alias used by the user, thus providing additional insight such as when the user is generating malicious content (e.g., computer viruses, etc.). For example, if one of the nodes 802 was identified as an entry point for a query associated with user aliases, the graph shown in graph database 800 can be the output of the query.

FIG. 9 shows an example of an output 900 of a query executed on a graph database, according to an embodiment. In some implementations, the output 900 can be displayed on a user device, such as the user compute device 130 of FIG. 1. The output 900 can be a graphical user interface, as seen in FIG. 9. The output 900 can include a plurality of nodes 902 that are interrelated via associations 904 (e.g., as shown as edges between notes). The output 900 can be generated by a system, such as the system 10 of FIG. 1, and by a method, such as the method 400 of FIG. 4, the method 500 of FIG. 5. The output 900 includes a subgraph that includes a subset of the data in the graph database. As described herein, at least one of the nodes 902 was an entry point for the query and the subgraph was generated based on the associations 904 and the query, which can indicate which associations 904 are desired.

The output 900 can allow for a user to further refine the output of the query. The output 900 includes query filters 910, for example, node labels, node properties, property values, type of search, a results limit, edge (e.g., associations) traversal information, layer limits, and/or additional information. The output 900 additionally includes output filters which can include a listing of the types of nodes included in the output 900, edge properties included in the output 900, and graph information (e.g., number of nodes, number of type of nodes, etc.). The user can select filters to display a subset of the nodes 902 or associations selected by the user.

FIG. 10 shows an example of a schema 1000 of a graph database (e.g., functionally and/or structurally similar to the graph databases described herein, such as the graph database 144 of FIG. 1), according to an embodiment. In some implementations, the schema 1000 can be based on a backing database such as, for example, Janusgraph, Neo4j, and/or the like. The schema 1000 includes a plurality of nodes 1002 that are interrelated via associations 1004 (e.g., as shown as edges between nodes). The nodes 1002 can include a plurality of properties that can be associated with the node 1002. For example, the properties can include a URL, username, display name, creation date, timestamp, license information, projection information, publication information, download information, and/or the like. The associations 1004 can define how the nodes 1002 are interrelated based on predetermined rules, such as, for example, authorship, property values, reference information, contribution information, membership information, follower information, usage information, and/or the like.

In some embodiments, a method for generating a graph database includes identifying at least one new package in at least one source database and generating a download request associated with the at least one new package. The method further includes, based on the download request, downloading the at least one new package from the at least one source database associated with the at least one new package. The method further includes preprocessing the at least one new package to define at least one text representation of the at least one new package. The method further includes cataloging the at least one new package based on the at least one text representation. The method further includes generating a graph database based on the cataloged at least one package.

In some implementations, the method further includes receiving at least one query associated with functionality of data of the at least one text representation in the graph database and analyzing, based on the at least one query, the data to define a functionality summary.

In some implementations, analyzing the data in the graph database includes generating a concrete syntax tree associated with the data.

In some implementations, the method further includes defining the functionality summary based on the concrete syntax tree.

In some implementations, the method further includes receiving at least one query associated with the graph database. The method further includes identifying at least one entry point based on the query and the graph database. The method further includes determining associations associated with the graph database based on the at least one entry point, and generating, based on the associations, a subgraph associated with data in the graph database that is related to the at least one entry point, the subgraph associated with interrelations between data.

In some implementations, the at least one entry point is stored in an entry point database.

In some implementations, the at least one entry point can be associated with a plurality of data types.

In some implementations, the associations are associated with at least one of a package, social information, a file, open-source exposure, or metadata.

In some implementations, the associations are nodes on the graph database.

In some implementations, cataloging the at least one new package includes identifying new associations based on the at least one new package and including the new associations as new nodes on the graph database.

In some implementations, the query corresponds to a malicious information query.

In some implementations, the at least one entry point can be associated with at least one index associated with the graph database.

It should be understood that the disclosed embodiments are not intended to be exhaustive, and functional, logical, operational, organizational, structural and/or topological modifications can be made without departing from the scope of the disclosure. As such, all examples and/or embodiments are deemed to be non-limiting throughout this disclosure.

All definitions, as defined and used herein, should be understood to control over dictionary definitions, definitions in documents incorporated by reference, and/or ordinary meanings of the defined terms.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine readable storage medium. A machine-readable storage medium may be, for example, but not limited to, a system, apparatus, or device, which employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

1. A method for generating a graph database, comprising:
identifying at least one new package in at least one source database;
generating a download request associated with the at least one new package;
based on the download request, downloading the at least one new package from the at least one source database associated with the at least one new package;
preprocessing the at least one new package to define at least one text representation of the at least one new package;
cataloging the at least one new package based on the at least one text representation; and
generating a graph database based on the cataloged at least one package.

2. The method of claim 1, further comprising:
receiving at least one query associated with a context of data of the at least one text representation in the graph database; and
analyzing, based on the at least one query, the data to define a contextual summary.

3. The method of claim 2, wherein analyzing the data in the graph database includes generating a concrete syntax tree associated with the data.

4. The method of claim 3, further comprising:
defining the contextual summary based on the concrete syntax tree.

5. The method of claim 1, further comprising:
receiving at least one query associated with the graph database;
identifying at least one entry point based on the query and the graph database;
determining associations associated with the graph database based on the at least one entry point; and
generating, based on the associations, a subgraph associated with data in the graph database that is related to the at least one entry point, the subgraph associated with interrelations between data.

6. The method of claim 5, wherein the at least one entry point is stored in an entry point database.

7. The method of claim 5, wherein the at least one entry point can be associated with a plurality of data types.

8. The method of claims 5, wherein the associations are associated with at least one of a package, social information, a file, open source exposure, or metadata.

9. The method of claim 5, wherein the associations are nodes on the graph database.

10. The method of claim 9, wherein cataloging the at least one new package includes identifying new associations based on the at least one new package and including the new associations as new nodes on the graph database.

11. The method of claim 5, wherein the query corresponds to a malicious information query.

12. The method of claim 5, wherein the at least one entry point can be associated with at least one index associated with the graph database.
